(19) United States
(12) Patent Application Publication
(10) Pub. No.: US 2008/0031584 A1
(43) Pub. Date: Feb. 7, 2008

(54) Apparatus and method for a singulation of polymer waveguides using photolithography

(75) Inventor: Jonathan Payne, San Jose, CA (US)

Correspondence Address: BEYER WEAVER LLP, P.O. BOX 70250, OAKLAND, CA, 94612-0250, US

(73) Assignee: National Semiconductor Corporation, Santa Clara, CA (US)

(21) Appl. No.: 11/498,356

(22) Filed: Aug. 2, 2006

(51) Int. Cl. G02B 6/10; B29D 11/00

(52) U.S. Cl. 385/132; 385/129; 385/130; 385/131; 264/1.24; 264/1.26; 385/31; 385/33

(57) ABSTRACT

Singulating polymer waveguides made on a substrate using photolithography. A first polymer cladding layer is formed and patterned on a first surface of a substrate to form a plurality of bottom cladding elements. Each of the bottom cladding elements are structurally independent from the other bottom cladding elements on the substrate. A second polymer layer is then formed and patterned on each of the bottom cladding elements to form a plurality of waveguide cores on each of the plurality of bottom cladding elements respectively. A third polymer top cladding layer is next formed over the plurality of waveguide cores on each of the bottom cladding elements respectively. In various embodiments, the individual waveguides can be separated from the substrate by using a selective tape or by cutting or sawing the substrate between the bottom cladding elements. The bottom cladding elements, the plurality of waveguide cores formed from the patterned second polymer layer, and the top cladding layer forming a plurality of polymer waveguides on the substrate.

### BACKGROUND OF THE INVENTION

1. Field of the Invention

The present invention relates generally to polymer waveguides used for light generation and reception in touch screen displays, and more particularly, to singulating polymer waveguides made on a substrate using photolithography.

2. Description of the Related Art

User input devices for data processing systems can take many forms. Two types of relevance are touch screens and pen-based screens. With either a touch screen or a pen-based screen, a user may input data by touching the display screen with either a finger or an input device such as a stylus or pen.

One conventional approach to providing a touch or pen-based input system is to overlay a resistive or capacitive film over the display screen. This approach has a number of problems. Foremost, the film causes the display to appear dim and obscures viewing of the underlying display. To compensate, the intensity of the display screen is often increased. However, in the case of most portable devices, such as cell phones, personal digital assistants, and laptop computers, the added intensity requires additional power, reducing the life of the battery in the device. The films are also easily damaged. In addition, the cost of the film scales dramatically with the size of the screen. With large screens, the cost is typically prohibitive.

Another approach to providing touch or pen-based input systems is to use an array of source Light Emitting Diodes (LEDs) along two adjacent X-Y sides of an input display and a reciprocal array of corresponding photodiodes along the opposite two adjacent X-Y sides of the input display. Each LED generates a light beam directed to the reciprocal photodiode. When the user touches the display, with either a finger or pen, the interruptions in the light beams are detected by the corresponding X and Y photodiodes on the opposite side of the display. The data input is determined by calculating the coordinates of the interruptions as detected by the X and Y photodiodes. This type of data input display, however, also has a number of problems. A large number of LEDs and photodiodes are required for a typical data input display. The position of the LEDs and the reciprocal photodiodes also need to be aligned. The relatively large number of LEDs and photodiodes, and the need for precise alignment, make such displays complex, expensive, and difficult to manufacture.

Yet another approach involves the use of polymer waveguides to both generate and receive beams of light from a single light source to a single array detector. The waveguides are usually made using a lithographic processes. For example, known polymer waveguides are made by forming a blanket first polymer bottom cladding layer on a substrate. A second polymer layer is next formed on the blanket polymer layer and patterned using photolithography to form waveguide cores. A third polymer layer is then formed over the waveguide cores. The first and third polymer layers have the same index of refraction N1, which is lower than the index of refraction N2 of the middle or second polymer layer. In various known polymer waveguides, the substrate is made from plastic, mylar, polycarbonate or other similar type resin materials. For more details on polymer waveguides, see for example U.S. application Ser. No. 10/758,759 entitled “Hybrid Waveguide”, and assigned to the assignee of the present invention, and incorporated herein for all purposes.

Singulation is a problem with the aforementioned polymer waveguides. A large number of waveguides are usually fabricated on a large substrate. The individual waveguides are laid out or arranged on the substrate in a nested “chevron” pattern. After the waveguides are fabricated, they are typically singulated using a dicing saw, similar to what is used to singulate the individual die on a semiconductor wafer. The problem with using a dicing saw is that a high degree of precision and smoothness is required, particularly at points where the waveguide lenses are located or where the waveguide will be coupled to an optical sensitive device (e.g., a CCD) or a light transmitting device (e.g., a laser, LED or LCD). If the cuts are not clean and precise, light may scatter, adversely effecting the operation of the waveguide. Use of dicing saw is also very expensive as the waveguides need to be individually cut. The time and equipment needed to singulate a large number of waveguides is therefore very costly. Furthermore, if the cuts are not precise enough, yields of the waveguides may be reduced, further increasing costs.

Accordingly, there is a need for a method of singulating polymer waveguides made on a substrate using photolithography.

### SUMMARY OF THE INVENTION

The present invention is directed to an apparatus and method for singulating polymer waveguides made on a substrate using photolithography. The apparatus and method includes forming and patterning a first polymer cladding layer on a first surface of a substrate to form a plurality of bottom cladding elements. Each of the bottom cladding elements are structurally independent from the other bottom cladding elements on the substrate. A second polymer layer is then formed and patterned on each of the bottom cladding elements to form a plurality of waveguide cores on each of the plurality of bottom cladding elements respectively. A third polymer top cladding layer is next formed over the plurality of waveguide cores on each of the bottom cladding elements respectively. The bottom cladding elements, the plurality of waveguide cores formed from the patterned second polymer layer, and the top cladding layer forming a plurality of polymer waveguides on the substrate. In various embodiments, the individual waveguides can be separated from the substrate by using a selective tape, cutting or sawing the substrate between the bottom cladding elements.

### BRIEF DESCRIPTION OF THE DRAWINGS

The invention, together with further advantages thereof, may best be understood by reference to the following description taken in conjunction with the accompanying drawings in which:

FIG. 1 is a touch screen display device using polymer waveguides.

FIG. 2A and 2B are top and cross section views of a known polymer waveguide.

FIG. 3A and 3B is a top view and cross section view of a plurality of polymer waveguides fabricated on a substrate.

FIGS. 4A through 4E is a sequence of cross section diagrams showing the fabrication of the polymer waveguides of the present invention.

FIG. 5 is a cross section of a polymer waveguide according to the present invention.

FIG. 6A through 6C is a sequence of cross section diagrams showing the singulation of the polymer waveguide according to one embodiment of the present invention.

In the figures, like reference numbers refer to like components and elements.

### DETAILED DESCRIPTION OF THE INVENTION

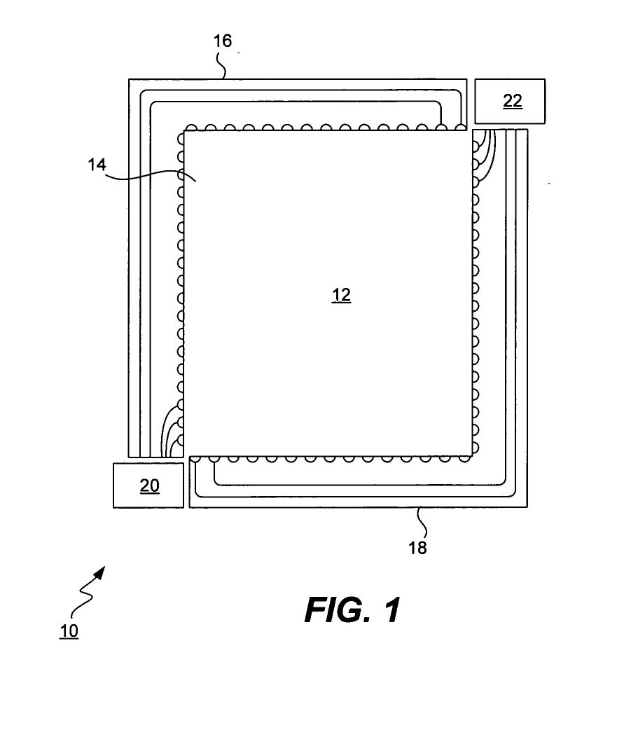

Referring to FIG. 1, a touch screen data input device is shown. The data input device 10 defines either a grid or “lamina” 12 of light in the free space adjacent to a touch screen 14. The grid or lamina 12 of light is created by an X and Y input light polymer waveguide 16. An opposing receives X and Y polymer waveguide 18 is provided to detect data entries to the input device by determining the location of interrupts in the grid or lamina 12 caused when data is entered to the input device. A light source 20, such as a laser or LCD, is optically coupled to the transmit waveguide 16. An optical processor 22 is coupled to the receive waveguide 18. During operation, a user makes a data entry to the device 10 by touching the screen 14 using an input device, such as a finger, pen or stylus. During the act of touching the screen, the grid or lamina 12 of light in the free space adjacent the screen is interrupted. The optical processor 22 detects the X and Y coordinates of the interrupt. Based on the coordinates, the processor 22 determines the data entry to the device 10. For more information on the data entry device 10, see U.S. application Ser. No. 10/817,564, entitled Apparatus and Method for a Data Input Device Using a Light Lamina Screen and an Optical Position Digitizer, filed on Apr. 1, 2004, incorporated by reference herein for all purposes.

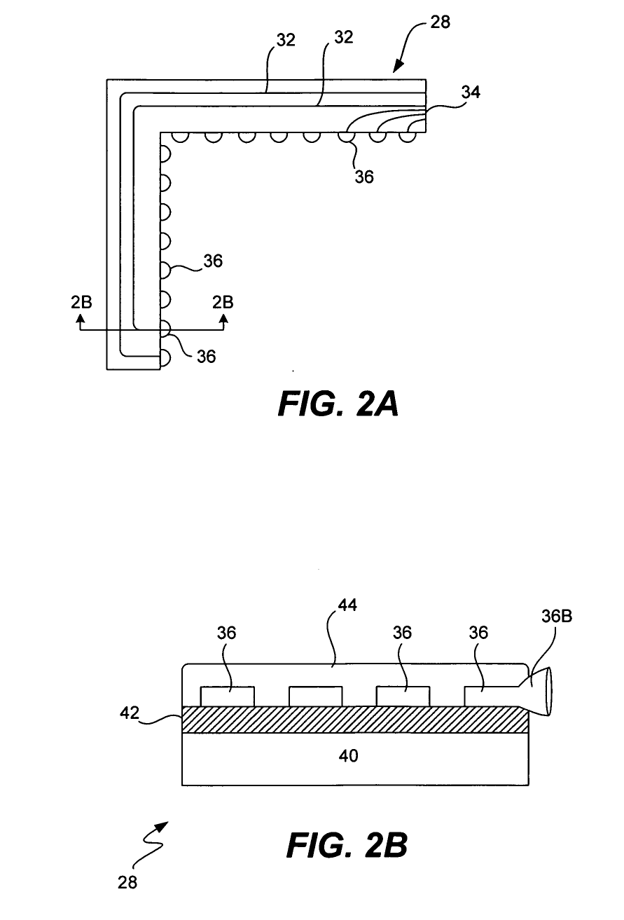

Referring to FIGS. 2A and 2B, top and cross section views of a known waveguide 28 is shown. The waveguide 28 is made using conventional fabrication techniques.

In FIG. 2A, the waveguide 28 includes a plurality of waveguide cores 32 that run between an optical coupling end 34 and a plurality of lenses 36. The lenses 36 are provided along the inner periphery of the waveguide 28 and are each optically coupled to a waveguide core 32. All of the waveguide cores 32 terminate at the optical coupling end 34. In situations where the waveguide is used as a transmitting waveguide 16, a light source 20 is optically coupled to the coupling end 34 of the waveguide. The light generated by the light source 20 travels down the plurality of waveguide cores 32 and is transmitted through the lenses 36 of the waveguide, creating the grid or lamina of light 12. On the other hand, if the waveguide 28 is used as a receive waveguide 18, then light received at the lenses 36 travels down the cores 32 to the optical coupling end 34. A processor 22 receives the light from all of the cores 32 and, based on the locations of any detected interrupts, determines a data entry.

In FIG. 2B, a cross section of the waveguide 28 along the line designed B-B′ through lens 36B is shown. The cross section reveals the structure of the waveguide 28 including a substrate 40, a first or bottom cladding layer 42, the plurality of cores 34 formed on the bottom cladding layer 42, and a top or third cladding layer 44. The bottom cladding layer 42 and the top cladding layer 44 are made of a polymer material having the same index of refraction N1. The cores 34 are made of a polymer material having a second index of refraction N2, which is greater than N1. In the embodiment shown, the cores 34 and lenses 36 are formed by patterning, using photolithography, a second polymer layer formed on the first polymer layer 42. In the embodiment shown, the lenses 36 are integrated with the plurality of cores 34 on top of the bottom cladding layer. The top or third polymer layer 44 is also patterned, using photolithography, so that a portion of the cores and/or lenses 36 are exposed to ambient air. In various other embodiments, the first, second and third polymer layers are made from Optically Clear Photopolymers, including, but not limited to Polysiloxanes, Polymethylmethacylates, epoxies, and other materials or a combination thereof. The substrate 40 can be one of the following types of materials, including mylar, polycarbonate, PET, sheet film plastics, polymers photo-imageable polymers, release coated glass, release coated ceramics, release coated semiconductors, and other rigid and flexible materials. For more details of polymer waveguides with partially exposed waveguide cores, see U.S. application Ser. No. 10/758,759 entitled “Hybrid Waveguide”, assigned to the assignee of the present invention, and incorporated by reference herein for all purposes.

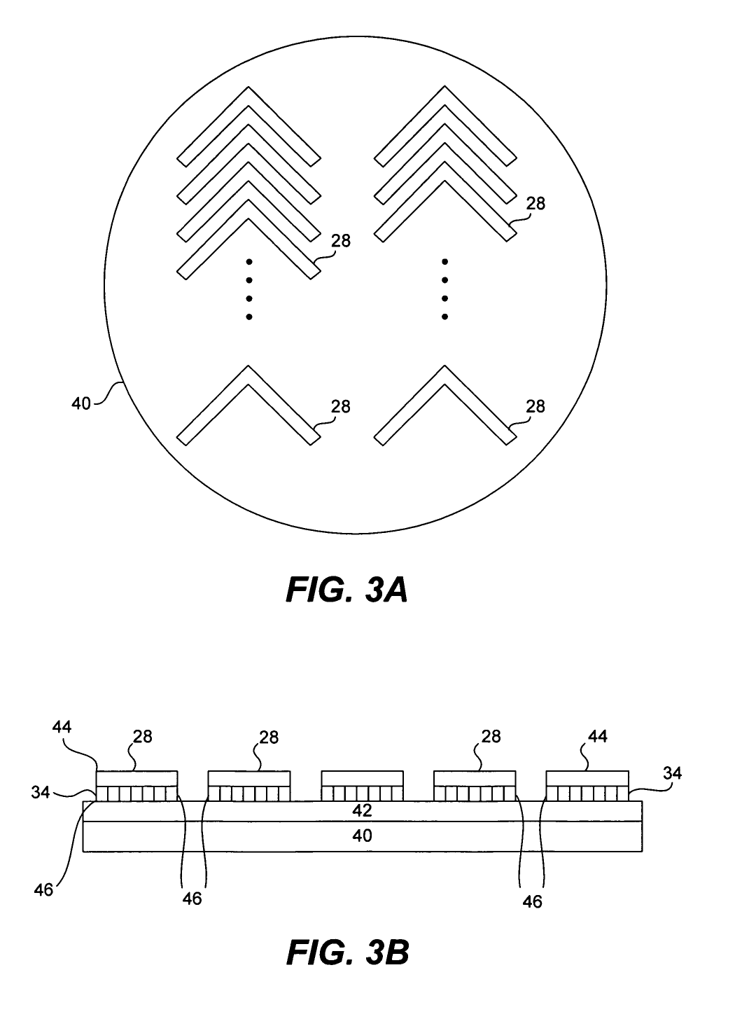

Referring to FIG. 3A, a top view of a plurality of the known polymer waveguides 28 on a substrate fabricated according to known methods is illustrated. The substrate 40 includes a plurality of the waveguides 28 arranged in a chevron pattern. According to various embodiments, the substrate 40 can be one of the following types of materials, including mylar, polycarbonate, or PET. The waveguides 28 are upside down “V” shaped arranged in the chevron pattern for the purpose increasing the number of waveguides 28 that can be fabricated at one time on a substrate 40 of a given size. It should be noted, however, that the shape and the arrangement of the waveguides 28 on the substrate 40 is arbitrary and does not necessarily have to be arranged in the pattern shown. After the waveguides are scribed or otherwise removed from the substrate 40, they can be used as either the transmitting or receiving waveguides 16, 18 as illustrated in FIG. 1.

Referring to FIG. 3B, a cross section of the substrate 40 is shown. In the cross section, a blanket first polymer layer 42 forming the bottom cladding layer for each of the waveguides 28 is provided on the substrate 40. Once the blanket polymer layer has been formed, the subsequent second polymer layer is deposited on the substrate 40 and patterned, forming the individual cores 34 and lenses 36. Thereafter, the third polymer layer is deposited and patterned, forming the top cladding layer 44 for each waveguide 28. The individual waveguides 28 are singulated from the substrate according to the prior art by cutting, using either a laser or saw, along the edges 46 of each waveguide.

As evident in the FIG. 3B, each of the waveguides 28 have a common bottom cladding layer 42. That is, the bottom cladding layer is a un-patterned, uniform layer, stretching across the entire top surface of the substrate 40. Consequently, the individual waveguides are not structurally independent from one another on the substrate 40.

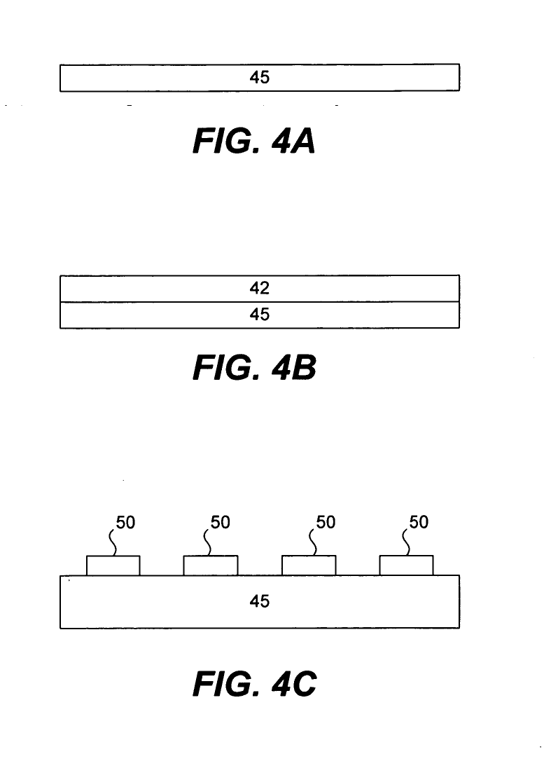

Referring to FIGS. 4A through 4E, a sequence of cross section diagrams showing the fabrication of polymer waveguides according to the present invention is shown. In FIG. 4A, a cross section of a substrate 45, such as that illustrated in FIG. 2, is shown. Again, the substrate 45 can be made of a plurality of materials, including sheet film plastics including Mylar, photopolymers, polymers, rigid materials including ceramics, silicon, glass with treated and untreated surfaces sufficient to enable ready release of waveguide elements following process completion. In FIG. 4B, the first polymer layer 42 is formed by depositing a blanket layer of polymer material across the entire top surface of the substrate 45. In a departure from the prior known processes for fabricating polymer waveguides, the first polymer layer 42 is patterned, using photolithography, to form a plurality of structurally independent bottom cladding elements 50 on the substrate 45, as illustrated in FIG. 4C. In the next step, the second polymer layer is deposited on each of the bottom cladding elements 50. As illustrated in FIG. 4D, the second polymer layer is then patterned using lithography to form the cores 34 (and lenses 36, but not shown for the sake of simplicity) on the bottom cladding elements 50. Thereafter, as illustrated in FIG. 4E, the third or top cladding layer 44 is formed over the cores 34 and lenses 36 on each bottom cladding element 50. Gaps 46, sometimes referred to as saw streets or scribe lines, are formed between the bottom cladding elements 50 on the substrate 45 between the individual waveguides 52.

As previously noted, the lenses 36 may be integrated with the plurality of cores 34 on top of the bottom cladding element 50. The top or third polymer layer 44 may also be patterned, using photolithography, so that a portion of the cores and/or lenses 36 are exposed to ambient air. Again, see the above mentioned U.S. application Ser. No. 10/758,759 entitled “Hybrid Waveguide”, for more details. In various other embodiments, the first, second and third polymer layers are made from optically clear photopolymers, polymers, epoxies, polysiloxanes, polymethylmethacrylates and other materials, or a combination thereof.

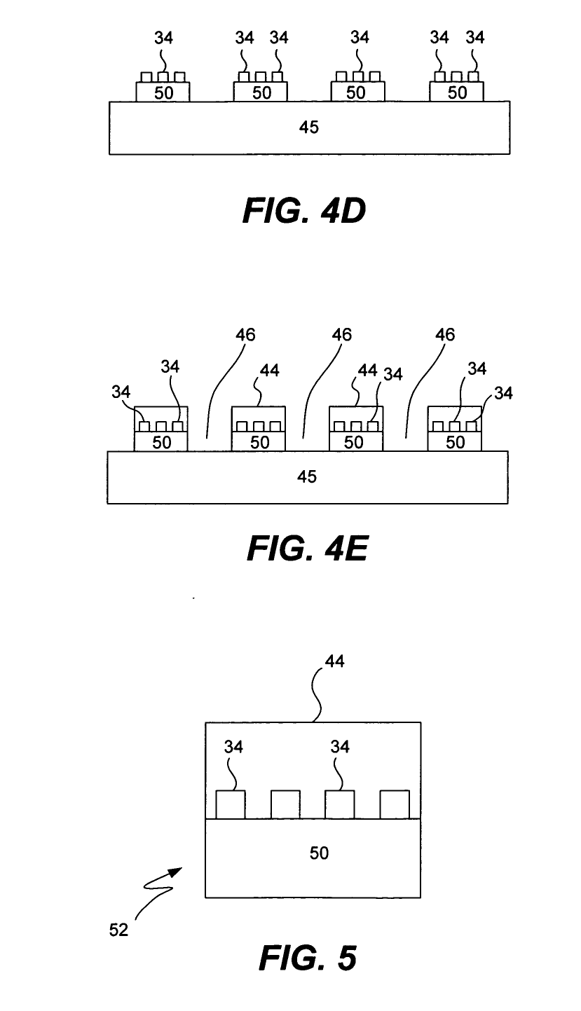

Referring to FIG. 5, a cross section of a polymer waveguide 52 according to the present invention is shown. The waveguide 52 includes the bottom cladding layer 50, the cores 34 (and lenses 36, not illustrated) and the top cladding layer 44 formed on the bottom cladding layer 50. The waveguide 52 differs from prior waveguides 28 as illustrated in FIGS. 2A and 2B in that the waveguide 52 has been separated from the substrate 40. Instead, the bottom cladding layer 50 and the top cladding layer 44 provide structural integrity for the waveguide 52.

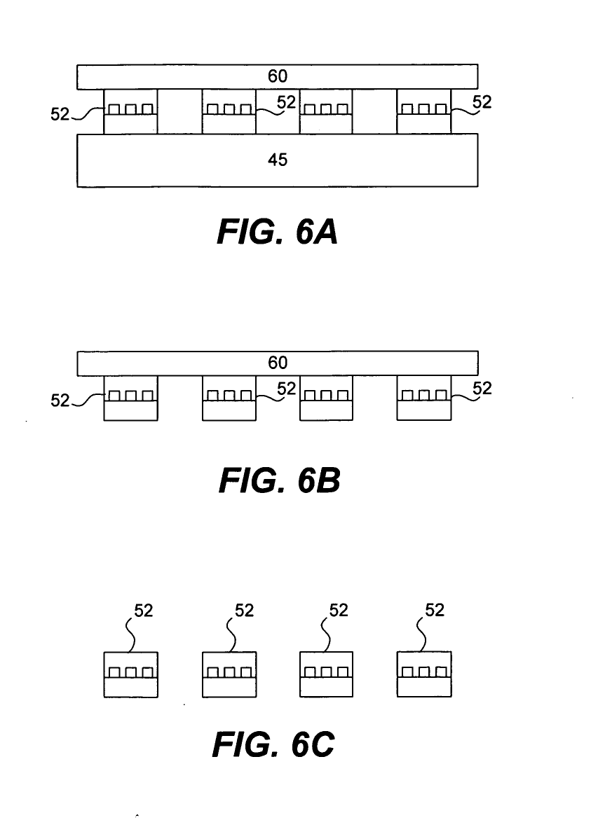

Referring to FIGS. 6A through 6C, a sequence of cross section diagrams showing the singulation of the polymer waveguides 52 from the substrate 45 according to embodiment of the present invention is shown. In FIG. 6A, a tape 60 is applied to the surface of the waveguides 52 opposite the substrate 45. The tape includes an adhesive surface that bonds to the top surface of the waveguides 52. As illustrated in FIG. 6B, the substrate 45 is then peeled away from the bottom surface of the waveguides 52. Thereafter, the waveguides 52 are released from the tape 60. In various embodiments, different types of tapes can be used. In one embodiment, the tape is a heat sensitive tape. After the waveguides 52 are peeled away from the substrate, heat is applied to the tape 60, causing the tape to release the waveguides. Alternatively, a UV sensitive tape can be used. When the tape is are exposed to UV energy, the waveguides 52 are released. In either case, the adhesion of the tape (sometimes referred to as selectively adhesive tape or dicing tape) can be selectively controlled by applying either heat or UV energy.

In other embodiments, the individual waveguides can be singulated by cutting the substrate 45 along the gaps 46 (i.e. saw streets or scribe lines). The cutting can be performed using either a laser or a saw.

Although the foregoing invention has been described in some detail for purposes of clarity of understanding, it will be apparent that certain changes and modifications may be practiced within the scope of the appended claims. Therefore, the described embodiments should be taken as illustrative and not restrictive, and the invention should not be limited to the details given herein but should be defined by the following claims and their full scope of equivalents.

We claim:

1. A method, comprising;
forming a first polymer cladding layer on a first surface of a substrate;
patterning the first polymer layer to form a plurality of bottom cladding elements on the first surface of the substrate, each of the bottom cladding elements structurally independent from the other bottom cladding elements patterned on the first surface of the substrate;
forming and patterning a second polymer layer on each of the bottom cladding elements, the second polymer layer being patterned to form a plurality of waveguide cores on the plurality of bottom cladding elements respectively; and
forming a third polymer top cladding layer over the plurality of waveguide cores of the patterned second polymer layer on each of the bottom cladding elements respectively, the bottom cladding elements, plurality of waveguide cores formed from the patterned second polymer layer, and the top cladding layer forming a plurality of polymer waveguides on the substrate.

2. The method of claim 1, further comprising separating the plurality of bottom cladding elements from the substrate to singulate the plurality of polymer waveguides.

3. The method of claim 2, wherein separating the plurality of bottom cladding elements from the substrate further comprises pealing the plurality of bottom cladding elements from the substrate.

4. The method of claim 2, wherein the separating the plurality of bottom cladding elements from the substrate further comprises:
applying a tape to the plurality of polymer waveguides;
peeling the plurality of polymer waveguides from the substrate; and
releasing the plurality of polymer waveguides from the tape.

5. The method of claim 4, wherein the tape is a heat sensitive tape and releasing the plurality of polymer waveguides further comprises applying heat to the tape.

6. The method of claim 4, wherein the tape is a UV tape and releasing the plurality of polymer waveguides further comprises applying UV energy to the tape.

7. The method of claim 1, singulating the plurality of waveguides by cutting the substrate between the plurality of bottom cladding elements.

8. The method of claim 7, wherein the cutting the substrate further comprises cutting the substrate using a laser.

9. The method of claim 8, wherein the cutting the substrate further comprises cutting the substrate using a scribing machine.

10. The method of claim 1, wherein the substrate consists of one of the following types of materials: mylar, polycarbonate, or PET.

11. The method of claim 1, wherein the first polymer layer and the third polymer layer have an index of refraction of N1.

12. The method of claim 11, wherein the second polymer layer has an index of refraction of N2.

13. The method of claim 12, wherein N2 is greater than N1.

14. The method of claim 1, wherein forming and patterning the second polymer layer further comprises patterning the second polymer layer to form a plurality of lenses optically coupled to the plurality of waveguides on the plurality of bottom cladding elements respectively.

15. The method of claim 14, wherein the patterning the second polymer layer further comprises patterning the plurality of lenses to be integrated with the plurality of waveguide cores on the plurality of bottom cladding elements respectively.

16. The method of claim 15, further comprising patterning the third polymer cladding layer so that a portion of the plurality of lenses are exposed to ambient air.

17. The method of claim 1, wherein the first polymer layer, the second polymer layer, and the third polymer layer consists of one or more of the following polymer materials: optically clear photopolymers, polymers, epoxies, polysiloxanes, polymethylmethacrylates and other materials, or a combination thereof.

18. The method of claim 1, further comprising patterning the first polymer layer using semiconductor photolithography processes to form the plurality of bottom cladding elements on the first surface of the substrate.

19. An apparatus, comprising:
a substrate;
a plurality of bottom cladding elements structurally independent from one another and formed on the substrate;
a plurality of waveguide cores and lenses formed on each of the plurality of bottom cladding element; and
a plurality of top cladding elements formed over the plurality of waveguide cores on each of the bottom cladding elements respectively.

20. The apparatus of claim 19, wherein the substrate is peel-able so that plurality of bottom cladding elements can be peeled away from the substrate.

21. The apparatus of claim 19, wherein the plurality of bottom cladding elements and the plurality of top cladding elements are both made of polymer material having an index of refraction of N1.

22. The apparatus of claim 21, wherein the plurality of waveguide cores are made of a second polymer material having an index of refraction of N2, wherein N1 is less than N2.

23. The apparatus of claim 22, wherein the polymer material and the second polymer material consist of: optically clear photopolymers, polymers, expoxies, polysiloxanes, polymethylethacrylates, or combination thereof.

24. The apparatus of claim 19, wherein the substrate consists of one of the following materials: optically clear photopolymers, polymers, epoxies, polysiloxanes, polymethylmethacrylates and other materials, or a combination thereof.

25. The apparatus of claim 1, wherein the plurality of top cladding elements are patterned to expose to ambient air the lenses on each of the bottom cladding elements respectively.
